(19) United States
(12) Patent Application Publication
(10) Pub. No.: US 2004/0128136 A1
(43) Pub. Date: Jul. 1, 2004

(54) Internet voice browser

(76) Inventor: Pourang Polad Irani, Winnipeg (CA)

Correspondence Address: Eugene F. Derenyi, Stikeman Elliott LLP, 1600-50 O'Connor Street, Ottawa, ON, K1P 6L2, CA

(21) Appl. No.: 10/665,507

(22) Filed: Sep. 22, 2003

Related U.S. Application Data
(60) Provisional application No. 60/412,000, filed on Sep. 20, 2002.

(51) Int. Cl. G10L 11/00

(52) U.S. Cl. 704/270.1

(57) ABSTRACT

There is provided a new and useful Internet Voice (IVB) to allow users to navigate, and to be “read” information from, the Web using a voice interface. The IVB reads, translates, and organizes HTML content into Voice XML (VXML), which provides a voice interface to read and interact with Web pages. When a user accesses a Web page, the IVB parses the HTML page, organizes the data into content and links, and then translates it into VXML to facilitate navigation over a phone device. In this manner, Web pages with HTML content can be accessed with a phone device without using a Personal Computer.

### CROSS REFERENCE TO RELATED APPLICATIONS

This application claims priority from U.S. Provisional application serial No. 60/412,000 filed Sep. 20, 2002.

### FIELD OF THE INVENTION

The present invention relates to browsing network-based electronic content and more particularly to a method and apparatus for accessing and presenting such content audibly.

### BACKGROUND OF THE INVENTION

The Internet has been the primary provider of information over the last decade, which has been referred to as the Information Revolution Age. This medium has consisted of several venues including news groups, chat lines, online discussion groups, information lists, and the most accessible and common source, the World Wide Web (WWW). The WWW consists of a web of interconnected computers serving clients through the Hyper-Text Transfer Protocol (HTTP). Residing at low level in the OSI 7-layer stack model, the HTTP protocol is capable of transferring text, video, audio, image, and other diverse types of information. The most abundant and easily accessible by providers of content is text information. This information is organized as a collection of Hyper-Text Markup Language (HTML) documents with associated formatting and navigation information. Formatting information such as Paragraphs, Tables, Fonts, and Colors adds a level of structure to the layout and presentation of the information. Navigation information consists of links that are provided for the purpose of focusing on details, additional related content, or other information connected to the site that is being browsed. An HTML page accessed by a client program (commonly referred to as a Browser) using the HTTP protocol is achieved via a Universal Resource Locator (URL). A URL address of a Web page consists of its location on a server, and the name of the HTML page requested.

In a society that is more globally connected and autonomously informed, users find themselves more dependent on the WWW. It is a main source for immediate information such as late breaking news, stock quotes, corporate data, and sometimes even mission-critical intelligence. However, current means for accessing the WWW are limited to having access through an Internet Service Provider (ISP) or a high-bandwidth access line typically connected to a stationary computer (laptops and WWW stations are more common lately; however, access to WWW information is limited and often inconvenient). This can be restrictive, especially to those who have to respond to needs on a real-time basis and who have schedules that conflict with accessing information through stationary modalities.

The World Wide Web Consortium (W3C) has adopted a standard referred to as Voice XML (VXML) with which voice response applications can be deployed for the Internet. It has built-in capabilities for combining content with real-time interactive communications. The standard is bringing about new types of converged services that go beyond the replacement services of voice, messaging, and IVR to web conferencing and network gaming.

Speech-enabled systems and interfaces (with Voice User Interfaces—VUIs) for Web applications offer several benefits over more traditional systems. Speech is the most natural mode of communication among people, and most people have years of speaking practice. Speech interfaces enable new users to use computing technology, especially users who do not type. Speech interfaces are also convenient for users when their hands or eyes are busy, for example, while driving a car, operating a machine, or assembling a device. Moreover, it's appropriate when keyboards are not convenient, such as for Asian language users, for users with small handheld devices, or for the accessibility impaired. Finally, speech interfaces enable mobility. They free users from the “office position”, and enable them to access computing resources from almost anywhere in the world, whether at home or on the move.

Prior work in the area of voice interfaces for content access can be classified under three general groups: text-to-speech converters, voice interfaces for navigating the WWW, and application providers for manually translating WWW content into speech.

Applications that fall under the first group are primarily concerned with translating text documents over to a voice interface such that mobile users, or users without a visual Web browser with which to access the WWW can still access some information. The users typically subscribe to a service from their mobile service providers, which can give them remote access to information over a wireless cellular. However, this information has been restricted to e-mail, fax documents, or attachments, which are simply text documents and therefore trivial to convert into some form of voice format. Such documents do not contain the variety of tags that are present within an HTML page, which requires careful examination and parsing in order to extract textual information.

The second group of applications has been focused on providing a navigational speech interface to traditional browsers available on most platforms. For example, the technology described in the U.S. Pat. No. 6,101,472, issued to International Business Machines Corporation on Aug. 8, 2000, is a data processing system and method for navigating a network using a voice interface. This technology provides a layer of interface to browsers residing on a machine, to allow a user to browse the WWW hands-off. Therefore, the only advancement of such technologies over more traditional browsers is the integration of a voice interface for inputting into the system links, or specific commands to direct the visual browser.

In the last group of applications, corporations have commercialized applications and many services that facilitate the conversion of a particular Web site into audible or voice format for access by a stationary phone or cellular device. These applications depend on having advance knowledge of the base structure of the Web site being translated. If the Web site were to change its structure, then these vendors would be required to re-configure their voice interfaces for the purposes of correctly extracting the information. These technologies have therefore focused on providing a solution to the content deliverer rather than to the content user. As a result, users can only access those Web pages that have been pre-translated by the content deliverer for a voice interface.

Hence, what is needed is a method and apparatus for browsing network-based electronic content and extracting and presenting such content audibly to stationary phone or cellular device users in a fully speech-integrated fashion in real-time. The content, navigation commands, and information foraging mechanisms are similar to those used with visual browsers but instead are accessible and delivered in real-time in response to voice commands.

### SUMMARY OF THE INVENTION

According to one embodiment of the invention, there is provided a method performed on a computer for accessing network-based electronic content via a stationary phone or cellular device comprising the steps of receiving a request via the phone or cellular device; retrieving a network-based document formatted for display in a visual browser; parsing the document to extract content therefrom; classifying the parsed content; converting the parsed content into VXML format and audibly presenting the content.

### BRIEF DESCRIPTION OF THE DRAWINGS

Further features and advantages of the present invention will become apparent from the following detailed description, taken in combination with the appended drawings, in which:

FIG. 1 is an overview of an Internet Voice Browser (IVB) system and environment according to the present invention;

FIG. 2 is a representation of a Web page with HTML tables and cells; and

FIG. 3 is a diagram depicting the architecture of an IVB system using Voice XML.

### DETAILED DESCRIPTION OF THE PREFERRED EMBODIMENTS

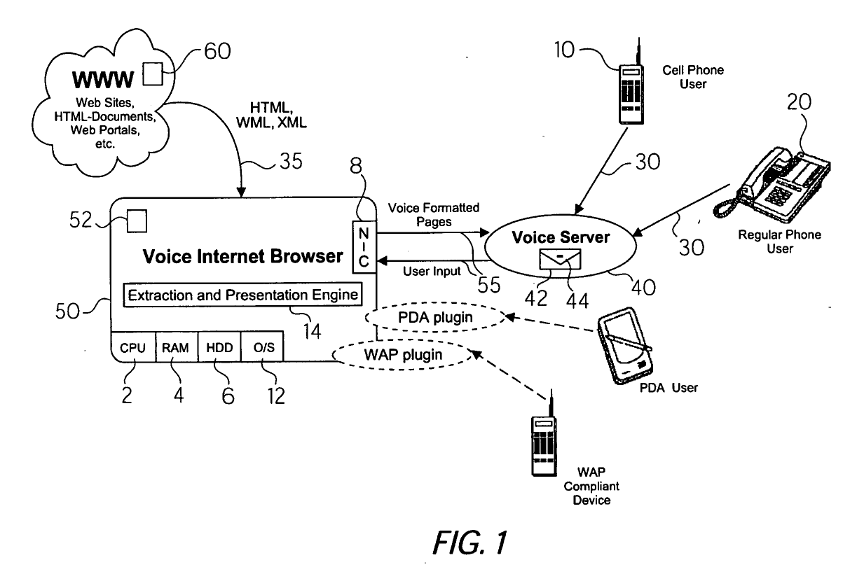

The present invention is a method and apparatus for browsing network-based electronic content and extracting and presenting such content audibly such that it can be accessed by users using a stationary phone or cellular device. FIG. 1 illustrates a network environment in which the method of the invention can be performed. The network environment comprises stationary phone 10 and/or cellular device 20 interconnected via a communications network 30 to a voice server 40. In the preferred embodiment, the VoiceGenie™ server is used as the voice server 40. The VoiceGenie™ server 40 is provided by VoiceGenie Technologies Inc. and can be accessed at http://www.voicegenie.com by selecting the VoiceGenie™ server option under the products menu at the above URL. The VoiceGenie™ server 40 acts as a gateway between the phone 10 or cellular device 20, and a voice internet browser server 50. The server 50 preferably has a central processing unit (CPU) 2, an internal memory device 4 such as random access memory (RAM) and a fixed storage device 6 such as a hard disk drive (HDD). The server 50 also includes network interface circuitry (NIC) 8 for communicatively connecting the server 50 to a communications network, preferably the Internet 55 which interconnects the server 50 with the voice server 40.

The server 50 can include an operating system 12 upon which applications can load and execute.

In an alternate embodiment, the servers 40 and 50 can be the same server.

The VoiceGenie™ server 40 is capable of receiving in-coming calls from a stationary phone or cellular device and connecting the call to a system that has a VXML file. The server 40 accepts voice or keypad input from a user and returns audible (namely voice) output from a VXML file.

In order to use the VoiceGenie™ server 40 in the present invention, a VoiceGenie™ account is first set up. The account is set up by accessing http://www.voicegenie.com and accessing the “developers” and “workshop members” pages on the website and following the instructions to create an account 42. Upon creating an account, the VoiceGenie™ server assigns the developer/user a unique extension number. The extension number is used by the developer/user to access the developer/user's VoiceGenie™ account 42. In setting up the account 42, the developer/user usually specifies a link 44 to the location where VXML files are located which are to be accessed through the VoiceGenie™ server 40. For example, the URL could be http://myserver.com/myfile.vxml. In the present invention, however, a .jsp (Java Server Pages™) file is specified: for example http://myserver.com/myfile.jsp.

In the preferred embodiment, the .jsp file resides on the voice internet browser server 50 and comprises Java Server Pages™ code which includes an extraction and presentation engine 14. The engine 14 takes an HTML file as input and transforms it into a VXML file so that it can be “read out” to a user accessing the HTML file through the voice server 40.

In operation, a user requesting to browse a particular Web page 60 using the cellular device 20 or stationary phone 10 dials into the voice server 40 and accesses the account 42. Access of the account 42 causes the server 40 to connect with the server 50 and tin particular the engine 14 using the URL 44. Accessing the engine 14 automatically launches the engine 14 to obtain (according to a pre-set link 46) a Web page 60 residing on the WWW and to extract content from it and present it to the user. In order to pre-set the link 46 to the Web page 60 a user 22 accesses an HTML Web page 52 on server 50. The page 52 contains text fields which include fields for filling in the location of the Web pages to be accessed. One or more URL links 46 to Web pages 60 can be specified. In the preferred embodiment, the news Web page www.cnn.com is specified for the URL link 46, as it is desired to browse a news site. The specified Web page 60 is saved as a text file. In the preferred embodiment, with a news page, the objective is to identify the main story of the news page and to have it read out to the user first and then to read out secondary news stories. It will be understood, however, that Web page content can be presented in any number of ways as dictated by the nature of the page and the needs of the user. The extraction and presentation engine 14 opens up the text file, accesses the desired Web page and formats the Web page 60 into a VXML format. In its simplest embodiment, the engine 14 converts the HTML Web page 60 without any preprocessing to a VXML file 62. The VXML file 62 can then be “read” line by line, by following the HTML line break tags <BR> and the paragraph break tags <P> and sending the output to the voice server 40 for audible output to the user. In an alternate embodiment, the Web page 60 is first parse to extract the desired content from the Web page 60 structure. The content is then classified and presented with the information and the links to the user. The browsing session begins and the user is given the information.

Users can skip particular sections of the Web page 60, navigate forward or backward, enter a specific link, and continue browsing in a similar fashion to browsing using a Web Browser such as Netscape® Navigator®. Users can either enter voice commands or keypad commands for the navigation using a high level menu 16 presented to the user by the engine 14.

During a browsing session using the engine 14 three major steps are performed: extraction, classification, and finally presentation. The input from a user is in the form of speech commands or keypad input for requesting a page or navigating the Web. This layer of the browsing session is limited by the capabilities of the presentation server such as a Voice Server 40 in the present invention.

The following steps are performed during a typical browsing session:

A user dials into the Voice Server 40 (typically using a 1-800 number) and accesses the account 42. Each user can pre-select the sites the user most frequently accesses as described above. Upon accessing the Voice Server 40 and the account 42, the server 40 accesses the voice internet browser server 50 and in turn the extraction and presentation engine 14 using the link 44 assigned to the account 42. When the engine 14 is accessed, it is automatically launched and builds a dynamic menu 16 that can be used by the user to connect to a pre-set list of Web sites 46.

When the user selects an appropriate selection on the menu 16, the engine 14 loads the page dynamically, i.e. the HTML page is parsed and deposited on the server 50. A selection can be made by voice or keypad input in response to options presented in the high level menu. In the preferred embodiment, the link to www.cnn.com is presented at option “one”. The user can either say “one” to link to the site or enter “1” by keypad entry.

The Voice Server 40 then links to the www.cnn.com site, parses the page and extracts the main news story and presents it to the user in voice format.

As with a visual browser, the user can chose links in the Web page 60, go backward, go forward, or go to the start of the session to choose another site.

The session ends when the user hangs-up.

The three major method steps of extracting, classifying and presenting Web content performed by the engine 14 and the server 40 are described below.

### Extraction

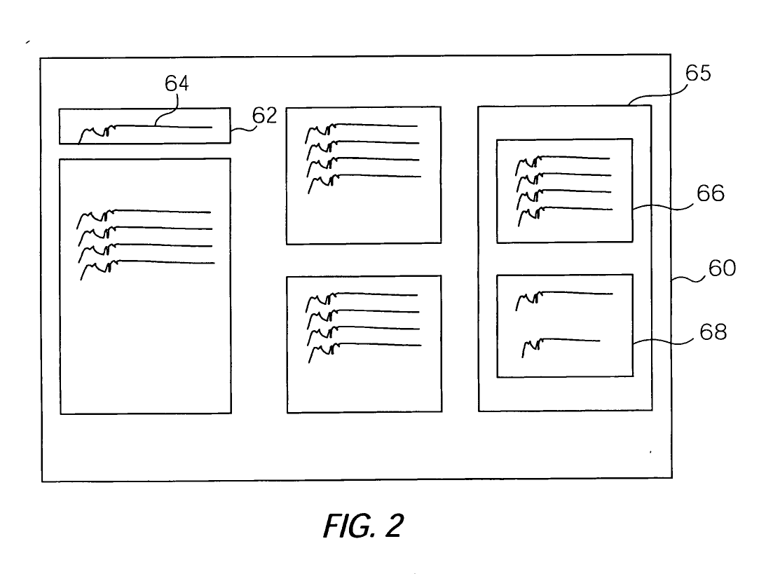

HTML uses “tags,” denoted by the “<>” symbols, within which is contained the actual name of the tag. Most tags have a beginning (<tag>) and an ending section, with the end shown by a slash symbol (</ tag>). For the purpose of this invention, tags are classified into three groups. One group of tags specifies formatting information such as BOLD (<B>), ITALICS (<I>), FONT SIZE (<FONT SIZE=“n”>), etc. These tags provide a consistent format to the text being viewed. A second group specifies links. There are numerous link tags in HTML that enable a viewer of the document to jump to another place in the same document, to jump to the top of another document, to jump to a specific place in another document, or to create and jump to a remote link, via a new URL, to another server. To designate a link, such as that previously referred to, HTML typically uses a tag having the form of, “<A HREF=/XX.HTML>YY</A>,” where XX indicates a URL and YY indicates text which is inserted on the Web page in place of the address. A link is defined using the HREF term included in the tag. In response to this designation, a visual browser will display a link in a different color or with an underscore to indicate that a user may point and click on the text displayed and associated with the link to download the link. At this point, the link is then said to be “activated” and a browser begins downloading a linked document or text. The third group of tags provides layout or structure. Web pages consist primarily of a structure made up of tables. Tables in HTML are identified by the <TABLE> and </TABLE> tags. These are used for laying out content, organizing sub-sections within sections, and dividing the page into logical units. A sample structure of a typical Web page is shown in FIG. 2.

Using the HTML tag information, the first step in extracting content is to parse the HTML source page 60 and capture the essence of the page 60. This information is placed in some form of memory structure suitable for any operation that will have to operate on the content of the page 60 at a later stage, such as searching, classifying, or consolidating. In the preferred embodiment, the memory structure is an array of values indicating primarily where the main content is, where the links are and where to go if links are requested. The array also stores information about table width and height, the number of cells in a table, and additional information such as type face, font size and font colours.

At the structural level, the most appropriate structure allows for capturing table data in ways that the program can randomly access each cell, manipulate the content, and tag each cell, by using flags that indicate the possible significance of the cell. This possible significance is termed semantic. These semantic values could indicate things such as “headline cell”, “related links cell”, or “main text cell”. The significance is assigned at a later stage, namely the classification stage. Other structural constructs, such as breaks and new paragraphs, must also be captured to ensure the representation of the page 60 by the structure are fairly accurate.

During this stage, several attributes need to be parsed out from the page 60 and become useful in both the classification phase and presentation process. For the presentation of the page 60, it is necessary to not only capture the text and images that make up the content of the page but also the various attributes associated with each text item, link, and image in the page 60 as much as possible. These attributes, called typographic features, represent information about the font size, font type, bold, underline, italics, etc. Some of this information will be used later to supplement the structural information.

Since HTML tags only provide indirect cues as far as content is concerned, the engine 14 uses one or more of the heuristic methods described below to identify content requested by the user.

EH1: Heuristic for Table Scanning

This heuristic method includes scanning for keywords in a particular text section of page 60. The engine 14 attempts to “read” the document and summarize using the words that could contain the main meaning of the text. These words are checked against a list of key words to decide its significance. If the significance is found, then the text is considered to be of the same significance.

EH2: Heuristic for Tables With Non-Text

The engine 14 ignores a table if any of the contents are non-text, not including JavaScript code. Such items are images, video, voice, embedded non-textual documents (not including PDF) and other similar forms of data, for example, table 2 in Web page 60 only contains image object 62 and is ignored by the engine 14 during parsing. When such items are received by the parser, they get discarded and at the same time the cell location is tagged within the internal data structure for the type of data present. The tagging is necessary in order to be able to produce a voice equivalent of the content at that location in the web page 60.

EH3: Heuristic for JavaScript Cells

The tool will execute the JavaScript code located at a cell. This stays in memory and any text obtained will be used by the engine. The text is tagged to indicate that the content is derived dynamically from another source. In certain cases the JavaScript code will either embed the textual information, and in other will provide links to external documents. When links to an external document is received then the code will register the links in the list of links available.

EH4: Heuristic for Table Cells With Links

If a table in a Web page contains a link, it is not ignored by the engine 14. For example, table 62 in Web page 60 contains link 64. Links are separated from the main content. The location of the link is replaced by an internal link tag which, when reached by the engine 14, will present the user with the option of entering into it. The internal link tag is produced by the engine 14 by converting the original HTML link to a link to a VXML file which is produced by the engine 14 upon accessing the HTML file of the link in real time. By following the link a subsequent page is retrieved and presented using the same heuristic methods used for the main page 60. In certain cases the links trigger content from within the same page. Such links are handled in a similar manner as others that hyperconnect the user to another page.

EH5: Heuristic for Related Links [Topic Related]

The engine 14 also relates links in the page 60 to one another. Links that are situated together spatially are considered [topic] related. When user requests for related information, links from the previous page (if there is one) that are together with this current page link are presented. Different groups of links are separated by table (or cell) boundary or some HTML tags that are usually use to separate different contents such as <HR>. For example, if page 60 is a news page for www.cnn.com, the main story could be in a table (for example table 65), which is divided into cells (for example cells 66 and 68). The cell 66 could contain text while the cell 68 could contain a link.

EH6: Heuristic for Expansion Links [Story Related]

Links that are together with the main story (may be in a separate sub table but right at the end of the story) are expansion links, directly related to the story (as opposed to topic). The engine 14, using the HTML tags in the Web page 60, determines the boundaries of tables within the page 60 and cells within the tables.

EH7: Heuristic for Links With Similarities

Links that have similar word(s) within the path or the article title (excluding some common words such as “more”, etc.) are considered related. The links are considered increasingly related as the similarity moves to the end of the path (deeper directory).

### CLASSIFICATION

The present invention uses a “cell centric method” to classify content to determine which content is the main content that should be read out first to the user. This method, as the name implies, relies heavily on the information provided by the cells in the page 60. A cell could be an actual cell of a table embedded in the page 60, or a logical (fabricated) cell created using other information available in the page itself, which uses certain heuristic methods that are described below.

In this method, a cell is considered the smallest operable unit of a Web page 60. It is stored in a Cell object, which is a model structure that is used to store the cell information. This structure provides the facility for the engine 14 to query various attributes and aggregate values of the content within the cell. Some possible queries are: 1) what does this cell mostly contain—links, text, or some other mix?; and 2) does this cell meet the criteria to be a headline cell, which is defined as a cell with highlighted text, bold text, or some other predefined condition?

In the most basic scenario, a cell will contain mostly text. When a cell contains a moderate amount of text, it would be considered a main content cell, which is in essence the content that is to be presented to the user first. On the other hand, if the cell contains only a small amount of text (<15 words), it would more likely be the headline of another cell. Thus, depending mostly on the amount of text inside a cell, the engine 14 will either present it to the user in the first pass or will continue the search for its content if it believes it is of headline type.

In the second scenario, a cell would contain many links. If the cell contains only links and most of the links are of meaningful segment (statistically each of them should be >3 words), they will be considered as being of a related section and will be grouped together to form a cohesive group. The engine will also go backward and look for a possible title of this section by using the rule laid out in the previous scenario. If the links are mostly short, the program will consider them as main categories. These categories usually do not have body as they often point to another network document that would contain the body of the category. The program will group them together under the title main categories.

In the third scenario, a cell would be of a complex nature. A cell is defined as complex when it is possible to dissect the cell into smaller autonomous cells that would meet the requirements of the first two scenarios.

CH1: Significance From Layout Heuristic Method

It is only natural for the author of the original HTML document to try to present to the viewer in the most legible manner. The engine 14 seeks to capitalize from this fact by scanning the structure of the document. The structure of the document is checked against a set of common ways that people indicate the significance of the text. For example, bold and underlined text is more important than regular text; and text of smaller font is of lesser important compared to larger text. Some other structural features of the page are also scanned. For example, the top/left row of table could contain header information and so we should process in a way that allow listener to understand the content of the table. This is clearly cannot be done by just reading the table from top to bottom.

CH2: Adjoining Cell Heuristic Method

Two cells that are close to one another are considered as being related. The relation is stronger if the cells have the same width space. Cells to the left and right whose borders extend beyond the borders of the cell in question will not be considered as related.

CH3: Biggest Cell Heuristic Method

The cell with the biggest area is considered to be the main cell in the page. If several cells are contending for the same amount of space then there are compared based on their content.

CH3a) the cell with the most number of links will be considered to be a secondary page. If the links are specially ordered in a left-to-right manner (see left-to-right heuristic below). If the ration of links to text approximates 1 (i.e. # links+amount of text/total amount of text) then the content is primarily link based and therefore is classified as secondary.

CH3b) the cell with the least amount of links and lowest link to text ratio will be considered as central.

CH3c) if two cells are contending for the main amount of text, the cell with the largest width will be considered as the main cell.

CH4: Left-to-Right Heuristic

Cells are scanned left-to-right and will be read in this order. The order is not essential when a main cell has been determined. This is achieved using CH3 described above.

CH5: Top-to-Bottom Heuristic

Cells are read top-to-bottom after being scanned left-to-right. The top most cells get presented first before the bottom cells.

CH6: Typeface Heuristic Method

Cells with similar types are considered to be related.

CH7: Heuristic Method for Presenting Table Data

There are many table that are actually series of ID data presented in a 2D manner. These tables have only header either on the top row or the left most column. These tables are converted so that each row data are read with a repeated header. The engine 14 would also attempt to decide whether the table is row major (meaning data are per-row and header is at the top row) or column major (meaning data are per-column and header is the leftmost column) and convert this appropriately.

CH8: Row/Column Orientation Method

When parsing table, if VoiceBrowser finds a row that contain <thread> all across then we know that this table is row oriented (meaning that the data are organized in rows, one row for each record). Row oriented table are also detected by checking if the top row of the table has <b> or some html code that increase the display font. Unlike the case of <thread> tag, VoiceBrowser does a secondary check on the second row to see if this format is not repeated. This is to increase the chance that we have detected the first row as header correctly. Another detection method is to check for the background and foreground color. If the first row is different compared to the rest of the rows in the table then VoiceBrowser considers it the header row.

If a header cannot be found, we then check again using the exact same sequence but this time we check for column major table. If a column major table is found, VoiceBrowser simply transposes the table so that the result is not a row major table. This makes it easier later on as the code does not have to worry about the orientation of the table.

It will be understood by those skilled in the art that one or more of the above heuristics can be used depending upon the content of a Web page which is desired to be extracted and presented to the user.

### PRESENTATION

The presentation of the content is provided in voice format, i.e., both input and output are voice-processed systems. Today, speech-enabled applications are possible due to improved chip design and manufacturing techniques, refinements in basic speech recognition algorithms, and improved dialog design such as that available using VoiceXML. VoiceXML was chosen as it is specifically designed to develop voice dialogs and is a high-level domain-specific language that simplifies application development. It separates the service logic from the Voice User Interface (VUI) and provides primitives to build interfaces, including:

Verbal menus and forms

Tapered prompts

Grammar specifying alternative words, which users can speak in response to questions

Instructions to the text-to-speech synthesizer about how to say words and phrases.

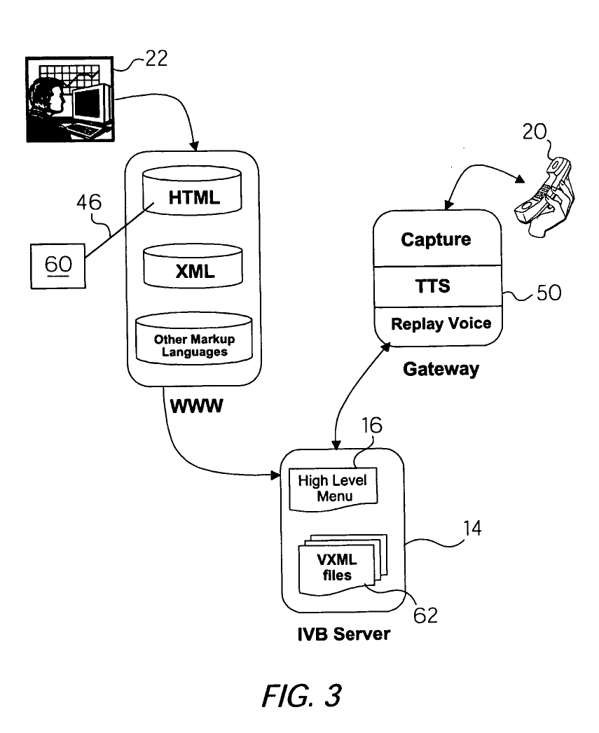

VoiceXML offers two usage models. One type is the user-initiated call, which is the model adopted for this invention. The user dials a Gateway. The Gateway loads VoiceXML pages from a pre-specified page on the Internet. The Gateway then interprets the VoiceXML pages and accesses service modules (HTML, DBMS, transactions, etc.). The architecture of this model is depicted in FIG. 3.

Once extracted, the content is then classified as information or as links. The links in the web page are wrapped around VoiceXML tags. The VXML file is then picked up by the gateway that reads the contents out to the user. As the request for more pages come in, the browser will translate these into VXML and leave it for the gateway to access.

The above-described components can be summarized under the following general pseudo-code outline:

STEP1: Wait for client connection

STEP2: Spawn independent process to handle client request

STEP3: Connect to http page

STEP4: Initialize parsing routines and variables

STEP5: WHILE NOT EOF

Begin parsing and populating central data structures

Extract table definitions and central contents

Classify content based on heuristics

END WHILE

STEP6: Obtain textual content from individual cells

STEP7: Convert textual content to VXML

STEP8: Send VXML document to server and present to user

STEP9: Wait for request including linking to subsidiary pages

In another embodiment of the present invention, a PDF (Portable Document Format) document embedded within an HTML page is the Web page 60. Such documents are textual in nature but also can represent a wide variety of other forms of data and in multiple forms of presentation. These include images, hyperlinks and tables some of which do not contain any textual information. The heuristics described above can therefore be altered to operate on such data. In particular, this data can also be demanded over non-voice activated devices such as a fax machine. For this particular instance the above-described methods have been implemented with alternate pathways for the handling PDF documents.

In this instance the pseudo-code for the central algorithm of the engine 14 is devised as follows:

STEP1: Wait for Client Connection

STEP2: Upon Connection obtain request for document (program is still in wait mode for other simultaneous requests)

STEP3: Obtain fax number for delivery of document

STEP4: Spawn process to dispatch document over fax

STEP5: Dispatch document over fax

STEP6: Close client connection

I claim:

1. A method for accessing network-based electronic content via a phone or cellular device comprising the steps of:
Receiving a request via the stationary phone or cellular device;
retrieving a network-based document formatted for display in a visual browser;
extracting content from the document;
converting the parsed content into a VXML format and audibly presenting the content.
